(19) United States
(12) Patent Application Publication
(10) Pub. No.: US 2009/0150390 A1
(43) Pub. Date: Jun. 11, 2009

(54) DATA RETRIEVING APPARATUS, DATA RETRIEVING METHOD AND RECORDING MEDIUM

(76) Inventor: Atsuhisa Morimoto, Nara-shi (JP)

Correspondence Address: BIRCH STEWART KOLASCH & BIRCH, PO BOX 747, FALLS CHURCH, VA, 22040-0747, US

(21) Appl. No.: 12/324,712

(22) Filed: Nov. 26, 2008

(30) Foreign Application Priority Data
Dec. 11, 2007 (JP) 2007-319550

(51) Int. Cl. G06F 7/06; G06F 17/30

(52) U.S. Cl. 707/5; 707/E17.014

(57) ABSTRACT

In a server apparatus including a document database for storing a plurality of documents, a retrieval log database for storing a retrieval history made when retrieving documents corresponding to an inputted retrieval condition from the document database, and an access log database for storing an access history made when browsing and printing documents, degrees of utilization of documents are calculated based on the respective retrieval history and access history, and documents are extracted from the document database based on the calculated degrees of utilization. When a request for an extraction result is received, the extraction result is presented to a PC that the user is using.

### CROSS-REFERENCE TO RELATED APPLICATION

This non-provisional application claims priority under 35 U.S.C. §119(a) on Patent Application No. 2007-319550 filed in Japan on Dec. 11, 2007, the entire contents of which are hereby incorporated by reference.

### BACKGROUND

1. Technical Field

The present invention relates to a data retrieving apparatus, a data retrieving method performed in the data retrieving apparatus, and a recording medium storing a computer program for realizing the data retrieving apparatus.

2. Description of Related Art

In recent years, with the spread of networks, there has been put into practice a system which stores data created using a computer and electric data produced from documents in a server, and allows a user to browse or edit the data stored in the server by using a terminal connected to the server through a network. In such a system, a large amount of data is stored in the server, and it is desired to enable the user to quickly retrieve desired data from the data stored in the server.

For example, Japanese Patent Application Laid-Open No. 2006-268789 discloses a document retrieving apparatus which retrieves data by reflecting keywords inputted by a user and the user's intension to retrieve, and presents a list of retrieval results to the user. The user's intension to retrieve is, for example, “retrieving new information that the user does not know”, or “trying to remember information that the user has seen but cannot remember”. Japanese Patent Application Laid-Open No. 2007-122685 discloses an information processing apparatus which determines that the higher the number of times of printing data, the greater the importance of the data; calculates the importance of data based on the number of times the data has been printed; and displays a list of data in order of the calculated importance, according to a request from the user.

### SUMMARY

According to Japanese Patent Applications Laid-Open No. 2006-268789 and No. 2007-122685, the user can obtain a list of data narrowed down by a predetermined condition, and can retrieve desired data from the obtained list. In Japanese Patent Application Laid-Open No. 2006-268789, however, there may be a case where no data corresponding to a keyword inputted by the user exists, and there is a problem that the user needs a long time until he/she obtains retrieval results because retrieval is started after the input of a keyword. In Japanese Patent Application Laid-Open No. 2007-122685, there may be a case where data that is important for the user is not determined to be important because the data has not been printed, and thus there is a possibility that the user cannot obtain a list of data that is really needed.

The present invention has been made with the aim of solving the above problems, and it is an object of the invention to provide a data retrieving apparatus, a data retrieving method and a recording medium, which enable a user to quickly find desired data by presenting data extracted based on the degrees of utilization of data to the user.

A data retrieving apparatus according to a first aspect of the invention is a data retrieving apparatus including storing means for storing a plurality of data items; retrieving means for retrieving data corresponding to an inputted retrieval condition from the storing means; retrieval log storing means for storing a log of retrieval performed by the retrieving means; access means for accessing data stored in the storing means; access log storing means for storing a log of access made by the access means; calculating means for calculating a degree of utilization of each of the data items stored in the storing means, based on the logs stored in the retrieval log storing means and the access log storing means, respectively; extracting means for extracting data from the storing means, based on the degrees of utilization calculated by the calculating means; receiving means for receiving a request for an extraction result obtained by the extracting means; and output means for outputting the extraction results when the receiving means receives the request.

A data retrieving apparatus according to a second aspect of the invention is characterized in that the calculating means includes: retrieval frequency obtaining means for obtaining a retrieval frequency of retrieval performed by the retrieving means from the log stored in the retrieval log storing means; and access frequency obtaining means for obtaining an access frequency of access made by the access means from the log stored in the access log storing means, and calculates the degree of utilization based on the retrieval frequency obtained by the retrieval frequency obtaining means and the access frequency obtained by the access frequency obtaining means.

A data retrieving apparatus according to a third aspect of the invention is characterized in that the access means is capable of browsing the data stored in the storing means, and that the access frequency is a frequency of the access means browsing the data stored in the storing means.

A data retrieving apparatus according to a fourth aspect of the invention is characterized in that, when calculating a degree of utilization based on the retrieval frequency and the access frequency, the calculating means calculates the degree of utilization by placing more weight on the access frequency than on the retrieval frequency.

A data retrieving method according to a fifth aspect of the invention is a data retrieving method which is performed in a data retrieving apparatus including storing means for storing a plurality of data items; retrieving means for retrieving data corresponding to an inputted retrieval condition from the storing means; retrieval log storing means for storing a log of retrieval performed by the retrieving means; access means for accessing data stored in the storing means; and access log storing means for storing a log of access made by the access means, the method including: a step of calculating a degree of utilization of each of the data items stored in the storing means, based on the logs stored in the retrieval log storing means and the access log storing means, respectively; a step of extracting data from the storing means, based on the calculated degrees of utilization; a step of receiving a request for an extraction result; and a step of outputting the extraction result when the request is received.

A computer-readable recording medium storing a computer program according to a sixth aspect of the invention is a computer-readable recording medium storing a computer program executable by a computer including storing means for storing a plurality of data items; retrieving means for retrieving data corresponding to an inputted retrieval condition from the storing means; retrieval log storing means for storing a log of retrieval performed by the retrieving means; access means for accessing data stored in the storing means; and access log storing means for storing a log of access made by the access means, the computer program including: a step of causing a computer to calculate a degree of utilization of each of the data items stored in the storing means, based on the logs stored in the retrieval log storing means and the access log storing means, respectively; and a step of causing the computer to extract data from the storing means, based on the calculated degrees of utilization.

In the first, fifth and sixth aspects, the degree of utilization of each data item is calculated based on the log of retrieval performed based on a retrieval condition specified by a user, and a log of access to data stored in the storing means. Then, data is extracted based on the calculated degrees of utilization, and outputted. In short, the user can obtain extraction results of data extracted based on the retrieval and data access performed by the user himself/herself.

In the second aspect, the degree of utilization of each data item is calculated from the retrieval frequency of data and the access frequency to data. It is thus possible to calculate a degree of utilization representing approximately the user's actual use of data.

In the third aspect, the degree of utilization of data is calculated by using the access frequency as the frequency of browsing data. It is thus possible to calculate a degree of utilization which more reflects the user's actual use.

In the fourth aspect, since a degree of utilization is calculated by placing more weight on the access frequency than on the retrieval frequency, it is possible to calculate a degree of utilization which more reflects the user's actual use.

In the first through sixth aspects, it is possible to narrow down a plurality of data items only to data of high degrees of utilization, or it is possible to sort the data in order from the highest degree of utilization. Hence, even when a retrieval condition is not specified, the user can easily find desired data from the narrowed data.

The above and further objects and features will more fully be apparent from the following detailed description with accompanying drawings.

### BRIEF DESCRIPTION OF THE SEVERAL VIEWS OF THE DRAWINGS

FIG. 1 is a block diagram showing the structure of a server apparatus according to an embodiment;

FIG. 2 is a view schematically showing the data structure of a retrieval log database;

FIG. 3 is a view schematically showing the data structure of an access log database;

FIG. 4 is a flowchart showing the operation of a server apparatus;

FIG. 5 is a flowchart showing the operation of the server apparatus;

FIG. 6 is a view schematically showing one example of a document list display mode on a PC; and

FIG. 7 is a view schematically showing one example of a document list display mode on a PC.

### DETAILED DESCRIPTION

Referring to the drawings, the following will explain a preferred embodiment of a data retrieving apparatus according to the present invention. In this embodiment, the data retrieving apparatus according to the present invention is explained as a server apparatus connected to a plurality of PCs (Personal Computers) through a network.

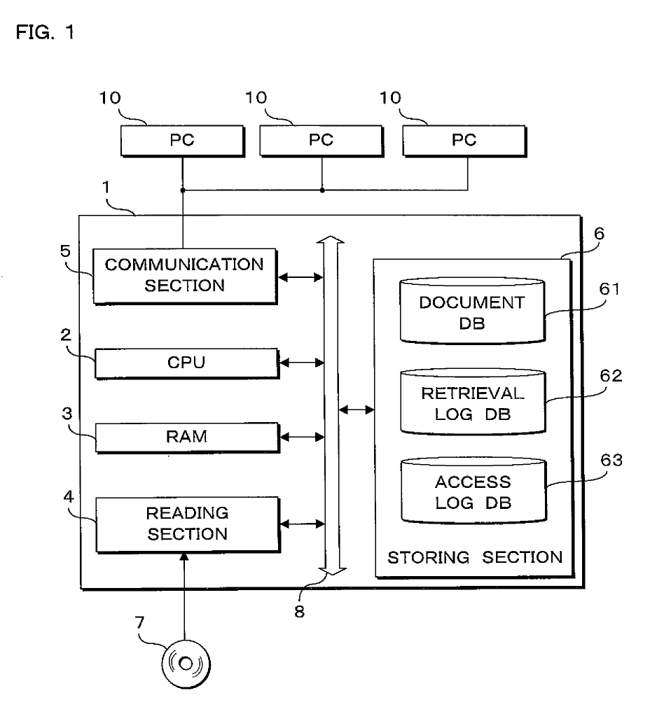

FIG. 1 is a block diagram showing the structure of a server apparatus according to this embodiment. As shown in FIG. 1, a server apparatus 1 is connected through a wired or wireless network to PCs 10 used by users to enable communication of data.

The PC 10 according to this embodiment is an ordinary personal computer capable of creating documents, and can send a created document to the server apparatus 1 by executing specific software. The document sent to the server apparatus 1 is managed and stored in the server apparatus 1. Moreover, the PC 10 is capable of retrieving a document corresponding to a keyword inputted by the user, for example, a document containing the keyword in its contents or title, from a plurality of documents stored in the server apparatus 1. Further, the PC 10 is capable of browsing the documents stored in the server apparatus 1, printing the documents from a printer, not shown, or downloading the document data.

The server apparatus 1 comprises a CPU (Central Processing Unit) 2, a RAM (Random Access Memory) 3, a reading section 4, a communication section 5 (receiving section and output section) for enabling connection (communication) with the PC 10, and a storing section 6, which are connected through a data bus 8.

The reading section 4 is a CD-ROM drive or the like for reading the recorded contents from a recording medium 7 such as a CD-ROM storing a computer program according to the present invention for realizing the server apparatus 1. The data read by the reading section 4 is recorded in the RAM 3.

The storing section 6 is a large-capacity storage apparatus such as a HDD (Hard Disk Drive) which is accessed by the CPU 2, and includes various kinds of databases, such as a document database (document DB) 61, a retrieval log database (retrieval log DB) 62, and an access log database (access log DB) 63, in a part of its storage area.

The document database 61 accumulates and stores various document data created by a user using the PC 10. The document database 61 stores the documents by categories, such as, for example, the created date and time, and document genre. Each document can be created by reading an original with a scanner.

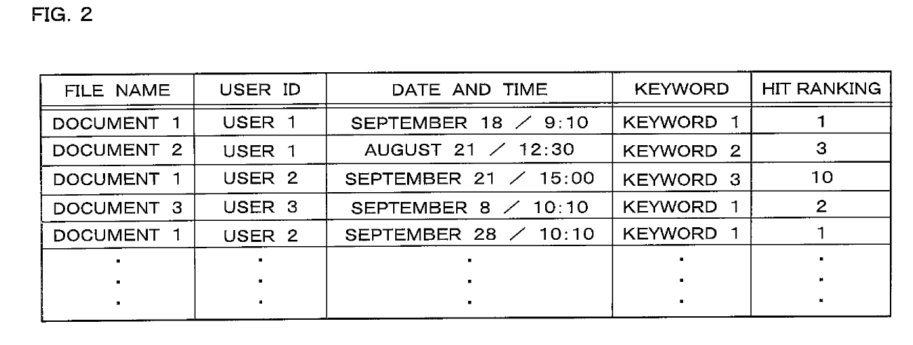

The retrieval log database 62 accumulates and stores a retrieval history made when retrieving documents corresponding to a keyword inputted from the PC 10 by the user. FIG. 2 is a view schematically showing the data structure of the retrieval log database 62. As shown in FIG. 2, stored in the retrieval log database 62 are the file names of documents hit by retrieval, user IDs of users who performed retrieval from the PC 10, the retrieval date and time, keywords, and hit ranking. The hit ranking is the order in which documents were hit by retrieval. For example, the first row in FIG. 2 indicates that a user with the user ID “User 1” performed retrieval based on the keyword “Keyword 1” on September 18 at 9:10, and that a document with the file name “Document 1” was hit first.

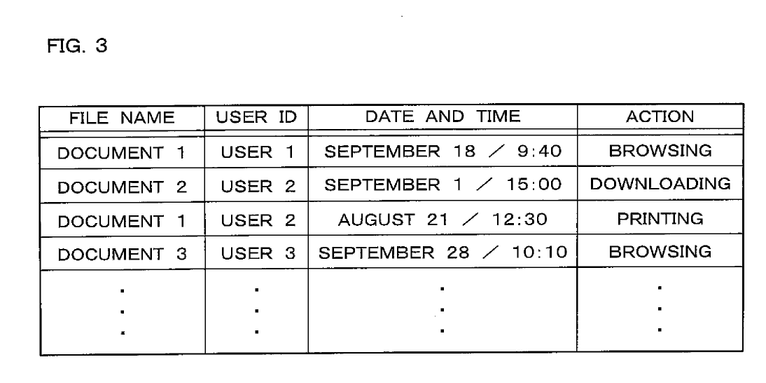

The access log database 63 accumulates and stores the access history when a user accessed a document from the PC 10. Here, access is browsing, printing, or downloading a document. FIG. 3 is a view schematically showing the data structure of the access log database 63. As shown in FIG. 3, the access log database 63 records the file names of documents accessed, user IDs of users who accessed the documents from the PC 10, the access date and time, and actions. The actions show the types of the above-mentioned access, such as browsing, printing, and downloading. For example, the first row in FIG. 3 indicates that a user whose user ID is “User 1” browsed a document with the file name “Document 1” from the PC 10 on September 18 at 9:40.

The retrieval history and access history are stored for a predetermined period T (for example, 180 days) in the retrieval log database 62 and the access log database 63. More specifically, when the predetermined period T elapses after starting recording the retrieval history and the access history, the recorded contents of the retrieval log datable 62 and access log database 63 are reset, and then new recording is started.

The CPU 2 is connected to the above-mentioned respective sections of the server apparatus 1 through the data bus 8, executes various software functions according to a program read from the recording medium 7 and stored in the RAM 3, and controls the respective sections of the server apparatus 1. For example, the CPU 2 executes a function of retrieving documents from the document database 61, a function of accessing each document, a function of obtaining a retrieval frequency from the retrieval log database 62, a function of obtaining a browsing frequency from the access log database 63, a function of calculating the degree of utilization of each document based on the retrieval frequency and the browsing frequency a function of creating a document list of documents stored in the document database 61 based on the degrees of utilization, and a function of sending the created document list to the PC 10.

The retrieval frequency represents the number of times each document was retrieved from the PC 10, and is obtained for each user. For example, the retrieval frequency of Document 1 by a user whose user ID is “User 1” is obtained based on the number of Documents 1 stored with the user ID “User 1” in the retrieval log database 62 shown in FIG. 2. The browsing frequency represents the number of times each document was browsed from the PC 10, and is obtained for each user. For example, the browsing frequency of Document 1 by a user whose user ID is “User 1” is obtained based on the number of Documents 1 stored with the user ID “User 1” and the action “browsing” in the access log database 63 shown in FIG. 3. The degree of utilization of a document is the frequency each user retrieved or accessed the document. Further, the document list is a list of the file names of documents extracted from the document database 61 and sorted based on the degrees of utilization. The document list is sent to the PC 10 and displayed on the PC 10. With the displayed document list, the user can check the documents sorted in order of the degrees of utilization, for example, in which a document used most frequently by the user is listed top.

The RAM 3 temporarily stores a program read from the recording medium 7 and information necessary for the CPU 2 to perform processing. For example, in the RAM 3, the retrieval frequency and browsing frequency obtained by the CPU 2, and the created document list are stored. In order to store them, it may be possible to provide an EPROM (Erasable and Programmable ROM) or a flash memory.

Next, the following will explain a calculation method of calculating the degree of utilization of each document from the retrieval frequency and the browsing frequency. The following will explain, as an example of the method of calculating the degree of utilization, a method of calculating a degree of utilization S (Document 1: User 1) of a document with the file name “Document 1” for a user whose user ID is “User 1”.

The degree of utilization S (Document 1: User 1) is given by Equation (1).

S(Document1:User1)+a*VF+b*VD+c*SF+d*SD (1)

In Equation (1), VF and VD are functions relating to the browsing frequency, and SF and SE are functions relating to the retrieval frequency. a, b, c, and d are weighting coefficients, and set so that a, b>c, d. In other words, the degree of utilization is calculated by placing more weight on the browsing frequency than on the retrieval frequency in the degree of utilization.

VF is the ratio of the browsed Document 1 to the total number of browsed documents, and given by Equation (2).

$$VF = \frac{browsing frequency of Document 1}{total number of browsed documents} \qquad ( 2 )$$

In Equation 2, the browsing frequency of Document 1 is the number of Documents 1 stored with the user ID “User 1” in the access log database 63 shown in FIG. 3. The total number of browsed documents is the number of all documents stored with the user ID “User 1” and the action “browsing” in the access log database 63 shown in FIG. 3.

VD is a coefficient calculated by the number of days passed from the browsed date of Document 1 to the calculation date, and given by Equation (3).

$$VD = \frac{\begin{matrix}SUM ( predetermined number of days - \\ \frac{( calculation date - browsed date of Document 1 )}{predetermined number of days} )\end{matrix}}{total number of browsed documents} \qquad ( 3 )$$

In Equation (3), the calculation date is the date of calculating the degree of utilization. The predetermined number of days is the number of days in the predetermined period T (for example, 180 days).

SF is the ratio of retrieved Document 1 to the total number of documents retrieved, and given by Equation (4).

$$SF = \frac{retrieval frequency of Document 1}{total number of documents retrieved} \qquad ( 4 )$$

In Equation (4), the retrieval frequency of Document 1 is the number of Documents 1 stored with the user ID “User 1” in the retrieval log database 62 shown in FIG. 2. The total number of documents retrieved is the number of all documents stored with the user ID “User 1” in the retrieval log database 62 in FIG. 2.

SD is a coefficient calculated by the number of days passed from a date at which Document 1 was retrieved to the calculation date, and given by Equation (5).

$$SD = \frac{\begin{matrix}SUM ( predetermined number of days - \\ \frac{( calculation date - retrieved date of Document 1 )}{predetermined number of days} )\end{matrix}}{total number of retrieved documents} \qquad ( 5 )$$

The retrieval frequency and the browsing frequency are obtained based on the retrieval history and the access history, and the retrieval history and access history are reset every predetermined period T. Accordingly, since the degree of utilization is always calculated by considering the most recent retrieval history and access history, its value reflects the user's actual use.

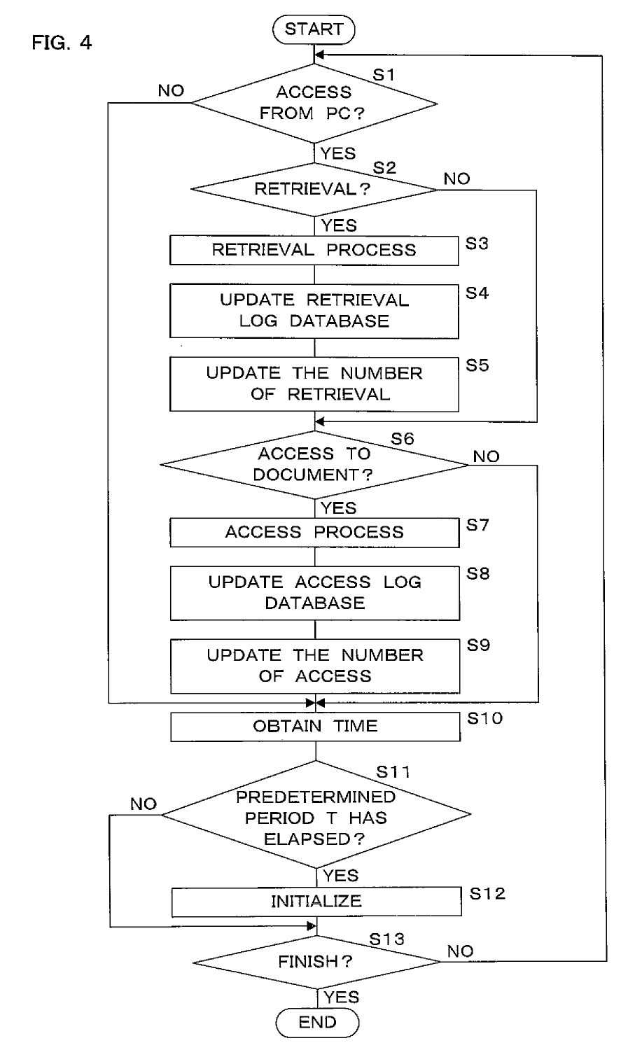

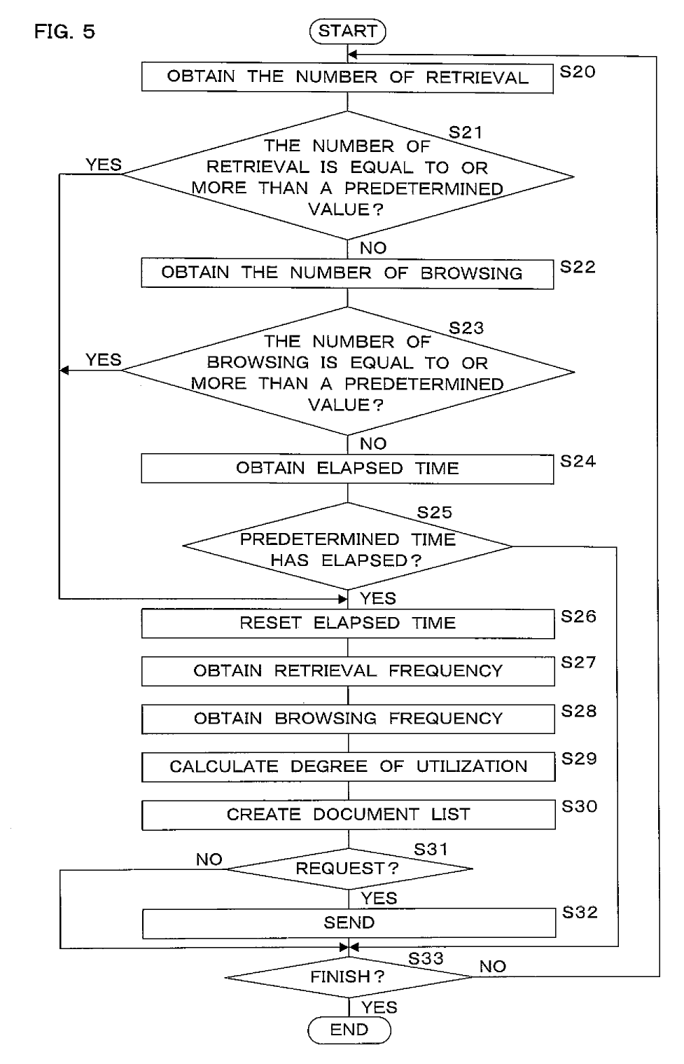

Next, the operation of the server apparatus 1 constructed as described above will be explained. FIGS. 4 and 5 are flowcharts showing the operation of the server apparatus 1. FIG. 4 is a flowchart showing the operation of creating the retrieval history and the access history, and FIG. 5 is a flowchart showing the operation of calculating the degree of utilization of a document. The CPU 2 starts each operation by executing the program read from the recording medium 7 and stored in the RAM 3. These operations are executed in parallel by the CPU 2.

First, the flowchart shown in FIG. 4 will be explained. The CPU 2 determines whether or not the communication section 5 has received access from the PC 10 (S1). If the communication section 5 has not received access from the PC 10 (S1: NO), the CPU 2 moves processing to S10. If the communication section 5 has received access from the PC 10 (S1: YES), the CPU 2 determines whether or not the communication section 5 has received a retrieval request from the PC 10 (S2).

If the communication section 5 has not received a retrieval request from the PC 10 (S2: NO), the CPU 2 moves processing to S6. If the communication section 5 has received a retrieval request from the PC 10 (S2: YES), the CPU 2 performs the retrieval process (S3), and updates the retrieval log database 62 (S4). More specifically, the CPU 2 retrieves documents corresponding to a keyword inputted from the PC 10, from the document database 61. Then, the CPU 2 extracts documents hit by the retrieval, and sends the extraction results to the PC 10. In this case, the CPU 2 sends the file names of the extracted documents, or locations (addresses) where the documents are stored, or the like, to the PC 10. Moreover, after finishing the retrieval, the CPU 2 records the file names of the documents hit by the retrieval, and the retrieval date and time in the retrieval log database 62. Thereafter, the CPU 2 updates the number of times retrieval was performed (S5). For example, every time the retrieval process is executed in S3, the CPU 2 increments the number of times retrieval was executed, and stores it in the RAM 3.

Next, the CPU 2 determines whether or not the communication section 5 has received an access request for a document stored in the document database 61 from the PC 10 (S6). If the communication section 5 has not received an access request from the PC 10 (S6: NO), the CPU 2 moves processing to S10. If the communication section 5 has received an access request from the PC 10 (S6: YES), the CPU 2 performs an access process, such as a browsing process and a printing process (S7), and updates the access log database 63 (S8). More specifically, according to the access request from the PC 10, the CPU 2 executes the browsing process, printing process, downloading process etc. on the document stored in the document database 61. After the access process is finished, the CPU 2 records the file name of the document on which the access process was performed, the access date and time, action etc. in the access log database 63.

Thereafter, the CPU 2 updates the number of times access was executed (S9). Every time the access process is executed in S7, the CPU 2 increments the number of times access was executed, and stores it in the RAM 3. The CPU 2 counts the number of times access was executed separately for each type of access process, that is, for each of the browsing process, the printing process, and the downloading process.

Next, the CPU 2 obtains a time from, for example, a timer IC (not shown) (S10), and determines whether or not the predetermined period T has elapsed (S11). In this case, the CPU 2 may obtain the current date from a calendar IC and determine whether or not a preset predetermined date has passed.

If the predetermined period T has not elapsed (S11: NO), the CPU 2 moves processing to S13. If the predetermined period has elapsed (S11: YES), the CPU 2 initializes the retrieval history, the access history, the number of times retrieval executed, the number of times access executed etc. (S12). Thereafter, the CPU 2 determines whether or not to finish the program read from the recording medium 7 and stored in the RAM 3 (S13). If the program is to be finished (S13: YES), the CPU 2 finishes the process shown in FIG. 4. If the program is not to be finished (S13: NO), the CPU 2 returns the processing to S1.

Next, the following will explain the flowchart shown in FIG. 5. First, the CPU 2 obtains the number of times retrieval was executed stored in the RAM 3 (S20). Every time the retrieval process is executed in S3 shown in FIG. 4, the number of times of retrieval executed is counted and the number of times of retrieval executed is stored in the RAM 3. The CPU 2 determines whether or not the number of times retrieval executed is equal to or more than a predetermined value (S21). The number of times retrieval executed is reset every time the predetermined period T elapses as described above.

If the number of times retrieval was executed is equal to or more than the predetermined value (S21: YES), the CPU 2 moves processing to S26. If the number of times of retrieval was executed is not equal to or more than the predetermined value (S21: NO), the CPU 2 obtains the number of times browsing was executed, which is stored in the RAM 3 etc. (S22). Every time the browsing process as one type of access process is executed in S7 in FIG. 4, the number of times browsing was executed is counted and stored in the RAM 3 etc. Then, the CPU 2 determines whether or not the number of times browsing was executed is equal to or more than a predetermined value (S23). The predetermined values in S21 and S23 may be one value, or more than one values. More specifically, it may be possible to determine whether the number of times retrieval was executed and the number of times browsing was executed exceed values, such as 10 times, 20 times, and 30 times.

If the number of times browsing was executed is equal to or more than the predetermined value (S23: YES), the CPU 2 moves processing to S26. If the number of times browsing was executed is not equal to or more than the predetermined value (S23: NO), the CPU 2 obtains an elapsed time from the timer IC, for example (S24). The elapsed time is the time (for example, one day) elapsed since the previous calculation of degree of utilization. Then, the CPU 2 determines whether or not a predetermined time has elapsed (S25). If the predetermined time has not elapsed (S25: NO), the CPU 2 moves processing to S33. If the predetermined time has elapsed (S25: YES), the CPU 2 moves processing to S26. In S26, in order to calculate a degree of utilization in the subsequent process, the CPU 2 resets the elapsed time that is the time elapsed from the previous calculation of degree of utilization (S26).

Next, the CPU 2 obtains the retrieval frequency of each document for each user from the retrieval log database 62 (S27). Then, the CPU 2 obtains the browsing frequency of each document for each user from the access log database 63 (S28). Thereafter, the CPU 2 calculates the degree of utilization of each document from the obtained retrieval frequency and browsing frequency (S29). In short, in this embodiment, without an instruction from the user, the degree of utilization is calculated every time a predetermined time (for example, one day) has elapsed, every time retrieving documents is performed a predetermined number of times or more, and every time browsing document is performed a predetermined number of times or more.

The CPU 2 extracts documents from the document database 61, sorts the documents, and creates a document list, based on the calculated degrees of utilization (S30). For example, by extracting documents in order from the highest degree of utilization, the CPU 2 sorts the documents stored in the document database 61 in order from the highest degree of utilization. Then, the CPU 2 creates a document list including a list of the file names of the sorted documents. In S29, the CPU 2 calculates the degree of utilization for each user. Accordingly, a document list is created for each user.

In S30, the CPU 2 may create a document list by extracting all documents stored in the document database 61 in order of the degrees of utilization, or create a document list by extracting only documents corresponding to a threshold degree of utilization or higher degrees of utilization. It may also be possible to create a document list by considering keywords used for retrieval or document genre. For example, it may be possible to create a document list based on the degrees of utilization obtained when retrieving was performed based on the most frequently used keyword, or when retrieving was performed based on a keyword with a high hit rank. In this case, the user can know the keyword that was frequently inputted by himself/herself and a list of documents hit by the retrieval based on the keyword.

Next, the CPU 2 determines whether or not a document list has been requested from the PC 10 (S31). If it has not been requested (S31: NO), the CPU 2 moves processing to S33. If the document list has been requested (S31: YES), the CPU 2 sends a document list matching the user ID of a user who made the request to the PC 10 through the communication section 5 (S32). Thus, by requesting a document list, without inputting a keyword and retrieving documents, the user can obtain the document list in which documents are sorted in order of the retrieval or access frequency so that a document retrieved, or accessed, most frequently by the user is listed top, and consequently the user can find a desired document more easily.

The CPU 2 determines whether or not to finish the program read from the recording medium 7 and stored in the RAM 3 (S33). If the program is to be finished (S33: YES), the CPU 2 finishes the process shown in FIG. 5. If the program is not to be finished (S33: NO), the CPU 2 returns the processing to S20.

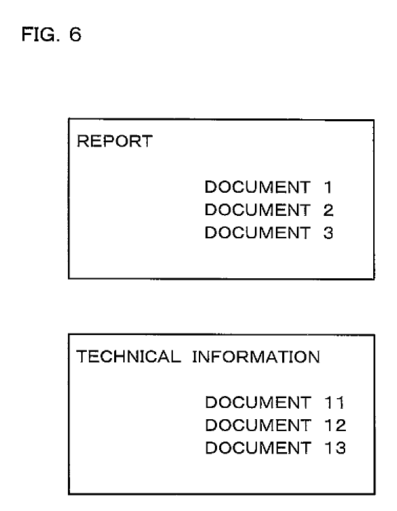

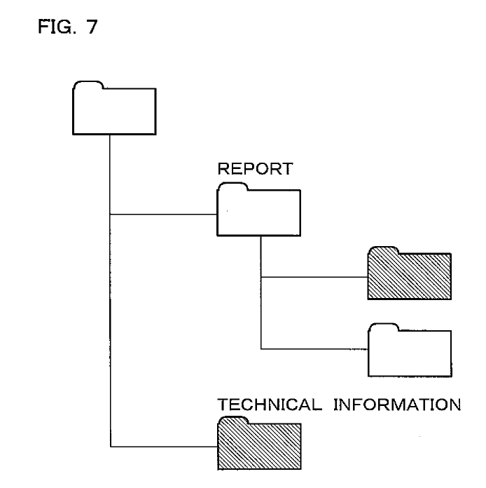

Next, the following will explain a document list display mode on the PC 10 which received the document list. FIGS. 6 and 7 are views schematically showing one example of a document list display mode on the PC 10.

The PC 10 which received a document list may display the entire document list, or display the document list by category if it is categorized as shown in FIG. 6. Moreover, as shown in FIG. 7, folders linked to the storage locations of the document data in the storing section 6 may be displayed in a tree structure, folders containing files may be displayed in different color, and desired data may be accessed by clicking the folder.

As explained above, the server apparatus 1 of this embodiment obtains, for each user, the retrieval frequency and the browsing frequency of a document, and calculates the degree of utilization based on the retrieval frequency and the browsing frequency. The server apparatus 1 creates a document list based on the degrees of utilization and presents it to the user. Hence, the user can check documents stored in the server apparatus 1 in order from the highest to lower degree of utilization of documents used by the user himself/herself, and consequently the user can easily find a desired document.

In this embodiment, although the degrees of utilization are calculated for each user, it is also be possible to calculate degrees of utilization for each user and then further calculate degrees of utilization by considering all users. For example, when all users are considered, the degree of utilization of a document with the file name “Document 1” for a user with the user ID “User 1” is given by Equation (6).

$$S ( Document 1 \text{:} User 1 ) = u 1 * S ( Document 1 \text{:} User 1 ) + u 2 * ( SUM ( S ( Document 1 \text{:} other users ) \qquad ( 6 )$$

In Equation (6), SUM (S(Document 1: other users)) is a coefficient obtained by adding the degree of utilization of users other than a user with the user ID “User 1”. u1 and u2 are weighting coefficients, and set so that u1<u2. In short, the degree of utilization is calculated so that the weight of the degree of utilization of User 1 is lower than that of other users. In this case, the user can check documents that are used at higher degrees of utilization by other users.

A method of calculating a degree of utilization is not limited to the method described in this embodiment, and a degree of utilization may be calculated by considering parameters other than the browsing frequency and retrieval frequency of documents. Further, although accessing documents is defined as browsing, printing and downloading documents using the PC 10, it is not limited to these.

In addition to the above-described server apparatus 1, the present invention is applicable to and executable by a computer program capable of executing the operation of a personal computer as a pseudo-data retrieving apparatus. In this case, as a recording medium for storing the computer program, it is possible to use a DVD-ROM, CD-ROM, FD. (flexible disk), and any other recording medium. By reading these recording media with a program reading apparatus incorporated into a computer system, the above-described processing is executed.

In this embodiment, the recording medium may be a memory which is not shown because processing is performed by a microcomputer. For example, the ROM itself can be a program medium, or the recording medium can be a program medium capable of being read by providing a program reading apparatus as an external storage device (not shown) and inserting the recording medium therein. In any case, the stored program can be accessed and executed by the microprocessor, or it is be possible to use a method in which a program code is read, the read program code is downloaded in a program storage area (not shown) of the microcomputer and executed. The program to be downloaded is stored in the main body of the apparatus beforehand.

Moreover, in this embodiment, since the system is connectable to communication networks including the Internet, the recording medium may be a medium for carrying a program in a flowing manner by downloading a program code from a communication network. In the case where a program code is downloaded from a communication network, a downloading program may be stored in the main body of the apparatus beforehand, or may be installed from another recording medium. The present invention can also be realized in the form of computer data signals embedded in a carrier wave in which the program code is embodied by electric transfer.

Although one preferred embodiment of the present invention is specifically explained above, the structures and operations can be changed suitably and are not limited to the above-described embodiment.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. A data retrieving apparatus, comprising:
a storing section for storing a plurality of data items;
a controller being capable of retrieving data corresponding to an inputted retrieval condition from said storing section; and
a retrieval log storing section for storing a log of retrieval performed by said controller; wherein
said controller is further capable of accessing data stored in said storing section,
said data retrieving apparatus further comprises an access log storing section for storing a log of access made by said controller,
said controller is further capable of:
calculating a degree of utilization of each of the data items stored in said storing section, based on the logs stored in said retrieval log storing section and said access log storing section, respectively; and
extracting data from said storing section based on the calculated degrees of utilization, and
said data retrieving apparatus further comprises:
a receiving section for receiving a request for an extraction result obtained by said controller; and
an output section for outputting the extraction result when said receiving section receives the request.

2. The data retrieving apparatus according to claim 1, wherein said controller is further capable of:
obtaining a retrieval frequency of retrieval performed by said controller from the log stored in said retrieval log storing section;
obtaining an access frequency of access made by said controller from the log stored in said access log storing section; and
calculating a degree of utilization based on the obtained retrieval frequency and access frequency.

3. The data retrieving apparatus according to claim 2, wherein said controller is capable of browsing data stored in said storing section, and
the access frequency is a frequency of said controller browsing the data stored in said storing section.

4. The data retrieving apparatus according to claim 2, wherein said controller is further capable of calculating a degree of utilization by placing more weight on the access frequency than on the retrieval frequency when calculating the degree of utilization based on the retrieval frequency and the access frequency.

5. A data retrieving method performed in a data retrieving apparatus including a storing section for storing a plurality of data items; a retrieving section for retrieving data corresponding to an inputted retrieval condition from said storing section; a retrieval log storing section for storing a log of retrieval performed by said retrieving section; an access section for accessing data stored in said storing section; and an access log storing section for storing a log of access made by said access section, said method comprising:
a step of calculating a degree of utilization of each of the data items stored in said storing section, based on the logs stored in said retrieval log storing section and said access log storing section, respectively;
a step of extracting data from said storing section based on the calculated degrees of utilization;
a step of receiving a request for an extraction result; and
a step of outputting the extraction result when the request is received.

6. A computer-readable recording medium storing a computer program to be executed by a computer having a storing section for storing a plurality of data items; a retrieving section for retrieving data corresponding to an inputted retrieval condition from said storing section; a retrieval log storing section for storing a log of retrieval performed by said retrieving section; an access section for accessing data stored in said storing section; and an access log storing section for storing a log of access made by said access section, said computer program comprising:
a step of causing a computer to calculate a degree of utilization of each of the data items stored in said storing section, based on the logs stored in said retrieval log storing section and said access log storing section, respectively; and
a step of causing the computer to extract data from said storing section based on the calculated degrees of utilization.
